(19) United States
(12) Patent Application Publication
(10) Pub. No.: US 2007/0175047 A1
(43) Pub. Date: Aug. 2, 2007

(54) Safety Haircut Scissors

(76) Inventor: Ian Cheng, Centerville, OH (US)

Correspondence Address: IAN CHENG, 9100 SURREY GATE PLACE, CENTERVILLE, OH, 45458, US

(21) Appl. No.: 11/307,246

(22) Filed: Jan. 27, 2006

(51) Int. Cl. B26B 13/00

(52) U.S. Cl. 30/233

(57) ABSTRACT

A safety haircut scissors comprises a guard plate with a curve shape surface on the outer side for safety and a V-shape opening slot on the front part for easy cutting engagement of said haircut scissors blades.

### BACKGROUND OF THE INVENTION

This invention relates to a safety haircut scissors which provides safety from hurting the person and in particular a child who receives the haircut during the process of hair-cutting.

When a haircut is made on a child with one regular haircut scissors, the sharp cutting edge and the contact of the blades with a child usually causes uneasiness and fear of getting hurt in a child's mind which renders a haircut on a child difficult.

In addition to the above mentioned causes, the seeing and hearing of the movement of the scissors by a child who receives the haircut usually worsen the situation and causes a child to panic and resist the operation of haircut and more importantly may cause hazard and harm to a child during the hair-cutting process.

It is, therefore, the object of present invention to design a haircut scissors which provides safety by keeping the person and in particular a child who receives the haircut from harmful bodily contact with the blades of the haircut scissors.

Additionally, the design of this safety haircut scissors by the use of a guard plate having a curve shape, smooth and comfortable surface will keep the sharp cutting blades of the scissors from the sight of the person and in particular a child who receives the haircut in order to prevent unnecessary uneasiness and aid the smooth operation of the hair-cutting process.

### DESCRIPTION OF THE DRAWING

An embodiment of the invention will now be described by way of example, and with reference to the drawing in which

FIG. 1 is a perspective view from the inner side of opened haircut scissors according to the invention;

FIG. 2 is a perspective view from the outer side of opened haircut scissors; and

FIG. 3 is a cross-sectional view on the line 8-8 of FIG. 2.

### DESCRIPTION OF THE INVENTION

Although the description hereof is detailed and exact to enable those skilled in the art to practice the invention, the physical embodiments herein described merely exemplify the invention which may be embodied in other specific structures. The scope of the invention is defined in the claims appended hereto.

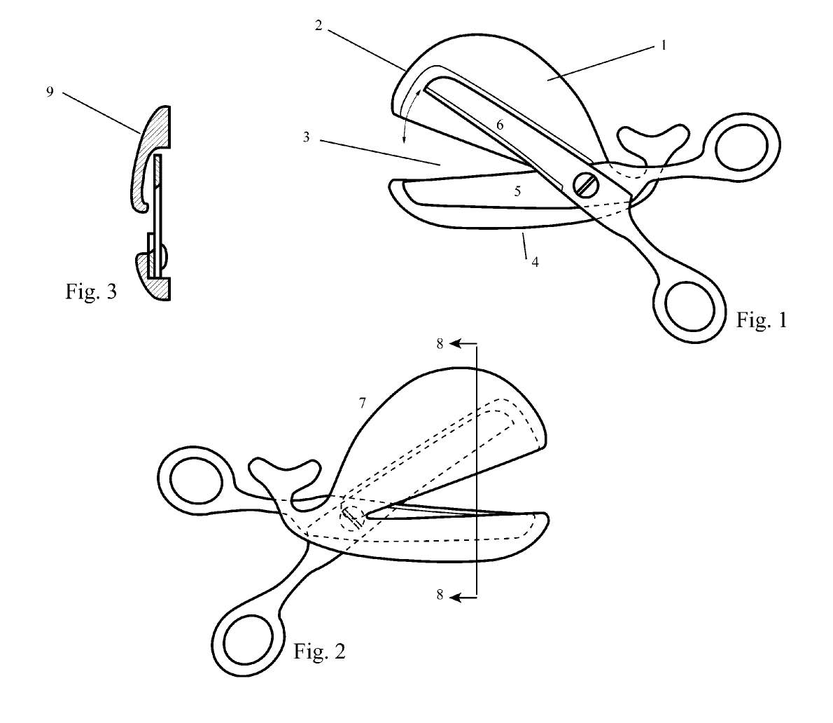

As best seen in FIG. 1, a guard plate 1 being made of plastic or other suitable material, having an arcuate shape on the front part 2 with a V-shape opening slot 3 and connected at the bottom end 4 to one of the pair of scissors blade 5 to thereby provide an efficient and enough space for the movement of another blade 6 of the pair of scissors for cutting engagement at all times.

With reference to FIG. 2, an outer side view of the safety haircut scissors of the present invention is depicted showing the outer side of said guard plate 1 to provide a safe and smooth contact of said guard plate with the person who receives the haircut during the process of hair-cutting.

It will be noted that the shape of the outer side area 7 of said guard plate 1 can always be designed to any suitable children friendly animal or cartoon figures as illustrated in FIG. 2 a whale shape of diagram.

With reference to FIG. 3, a cross-sectional view on the line 8-8 of FIG. 2. showing a curve shape surface 9 on the outer side of said guard plate 1. The boundaries of said pair of scissors blade 5, 6 to provide means for hair-cutting in said V-shape opening slot 3 are always within the outer edge of said guard plate.

As can be understood by one skilled in this art the invention defined herein above may be embodied in many specific forms without departing from the spirit or essential characteristics thereof. The present embodiments are, therefore, to be considered in all respects as illustrative and not restricted. The scope of the invention is to be taken as defined by the appended claims rather than by the foregoing description and all changes which come within meaning of the range of the equivalents of the claims are, therefore, intended to be embraced therein.

What is claimed is:

1. A safety haircut scissors comprising a guard plate having an opening slot and connected at one end to one of said pair of scissors blade to provide means for hair-cutting in said opening slot so that the boundaries of said haircut scissors blade are always within the outer edge of said guard plate.

2. A safety haircut scissors comprising a guard plate having a curve shape surface on the outer side to provide a safe and smooth contact of said guard plate with the person who receives the haircut during the process of hair-cutting.
